(19) United States
(12) Patent Application Publication
(10) Pub. No.: US 2009/0177856 A1
(43) Pub. Date: Jul. 9, 2009

(54) METHOD AND APPARATUS FOR AUTOMATED BACKUP PROCESS

(76) Inventor: Jason Joseph Herne, Endicott, NY (US)

Correspondence Address: Duke W. Yee, Yee & Associates, P.C., P.O. Box 802333, Dallas, TX, 75380, US

(21) Appl. No.: 11/971,658

(22) Filed: Jan. 9, 2008

(51) Int. Cl. G06F 12/00

(52) U.S. Cl. 711/162; 711/E12.001

(57) ABSTRACT

A computer implemented method, apparatus, and computer usable program code for backing up data. In response to a request to backup the data from a data processing system, a unique identifier is identified for the data processing system. Also responsive to the request, the data is backed up to a storage system to form backup data. The unique identifier for the data processing system is associated with the backup data.

### BACKGROUND OF THE INVENTION

1. Field of the Invention

The present invention relates generally to an improved data processing system and in particular to a method and apparatus for processing data. Still more particularly, the present invention relates to a computer implemented method, apparatus, and computer usable program code for backing up data.

2. Description of the Related Art

Backing up data involves making copies of the data such that the additional copies may be used to restore the original data if the original data is damaged or lost. These additional copies of data may be referred to as backups or backup data. Backup data may be used to restore a computer after a hardware failure, such as the failure of a hard disk drive. Backup data also may be used to restore data that may have been accidentally deleted or corrupted during normal use of a computer.

Many circumstances are present that make it desirable to have a backup of data from a computer. Backups of data may be made on a periodic basis to guard against a failure of a computer. For example, the hard disk drive of a computer may fail in a manner such that the data may be lost or corrupted. With backup data, the hard disk drive may be replaced and the backup data may be used to restore the data on the hard disk drive.

Another scenario in which a backup of data may be made is during maintenance or repair of a computer. A backup of the data is made from the data or storage devices in the computer prior to performing maintenance and/or repair operations. This backup of data guards against a situation in which an unforeseen circumstance may cause the data on the computer to be corrupted or lost. In some cases, the repair may require restoring an operating system, which typically involves destroying or erasing all of the data on the computer.

Currently, backups of computers are performed using software or computer programs that copy data from the computer to a target storage system. The user starts the backup software on the source computer and chooses parameters to govern the backup process. These parameters may include, for example, a selection of what data to backup, whether to compress the data, whether to encrypt the data, and the target storage system for the backup. These types of steps are time consuming and tedious when numerous computers are to be backed up.

Therefore, it would be advantageous to have a computer implemented method, apparatus, and computer usable program code to overcome the above described problems with respect to backing up data.

### SUMMARY OF THE INVENTION

The illustrative embodiments of the present invention provide a computer implemented method, apparatus, and computer usable program code for backing up data. In response to a request to backup the data from a data processing system, a unique identifier is identified for the data processing system. Also responsive to the request, the data is backed up to a storage system to form backup data. The unique identifier for the data processing system is associated with the backup data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram illustrating components used in backing up data in accordance with an illustrative embodiment;

FIG. 4 is a diagram illustrating components used in restoring data in accordance with an illustrative embodiment;

FIG. 5 is a high level flowchart of a process for backing up data in accordance with an illustrative embodiment;

FIG. 6 is a flowchart of a process for backing up data in accordance with an illustrative embodiment; and

FIG. 7 is a flowchart of a process for restoring backup data in accordance with an illustrative embodiment.

### DETAILED DESCRIPTION OF THE PREFERRED EMBODIMENT

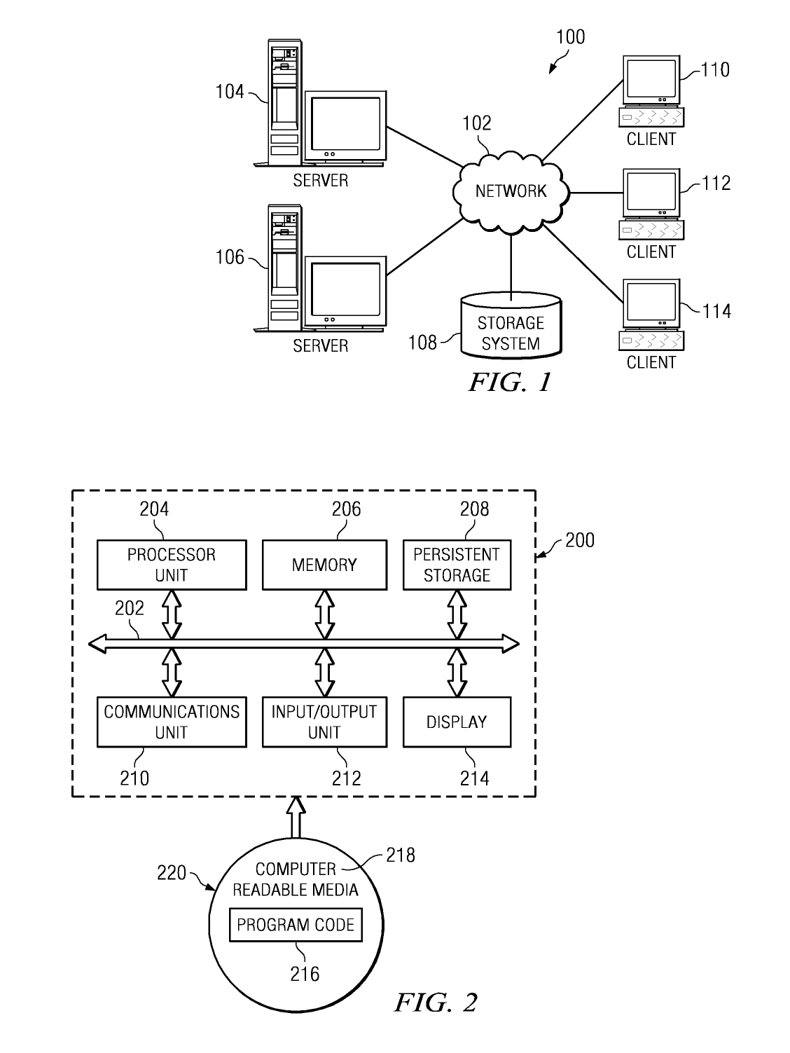

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

In one illustrative example, network data processing system 100 may be a network within a repair facility. In this illustrative embodiment, clients 110, 112, and 114 may be computers that are connected to network 102 for maintenance or repair operations. In performing maintenance and/or repair operations, a backup of data located on storage devices in clients 110, 112, and 114 may be made prior to performing these operations. This backup may be made to computers, such as server 104 or server 106. The backups also may be made to storage system 108.

When serving the purpose of storing backups, server 104 and server 106 may also be referred to as storage systems. These storage systems may include various types of storage devices for storing the backup of data from clients 110, 112, and 114. The storage systems may include, for example, without limitation, hard disk drives, data disk drives, optical disk drives, solid state disk drives, and any combination of these or other suitable types of storage devices.

In other embodiments, the backing up of data may be performed within an organization or between different organizations in which network data processing system 102 may include the Internet, a wide area network, a local area network, and/or any other suitable combination of networks. The different illustrative embodiments provide a backup that may be performed with less user input than currently available backup processes. In some embodiments, the backup process may be totally automated requiring no user input other than causing the backup process to be received by the computer from which the backup is to be made.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media x18 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The introduction of a backup process and/or a restore process in these examples may be made by introducing a computer readable media, such as computer readable media 218 on which program code 216 contains the backup process and/or restore process. In other embodiments, the backup process may be received by the data processing system connecting to the network using communications unit 210. With this type of embodiment, data processing system 200 may receive code used to load the backup process in response to connecting to the network.

The different illustrative embodiments recognize that with current backup systems a user is required to start a backup from the source data processing system, choose parameters governing the backup process, and then start the backup process. This type of backup system requires the user to have some knowledge of the system to be backed up as well as the target system to which the backup is to be sent. In the example involving a computer maintenance and repair facility in which many customer systems are received on a daily basis, a faster and simpler backup process is desirable.

The different illustrative embodiments provide a computer implemented method, apparatus, and computer program code in which the user may merely introduce the backup process onto the computer from which the backup is to be made. All other actions may be automatically performed by the backup process without requiring further user input.

In response to a request to backup data from the data processing system, a unique identifier of the data processing system is obtained. This unique identifier may be, for example, a media access control address for a network adapter. The unique identifier may be any information that uniquely identifies a particular data processing system from other data processing systems. In another example, the unique identifier may be a serial number for the data processing system, a processor identifier, and/or other suitable information that may be located on the data processing system or a device connected to the data processing system. In fact, in some embodiments, a combination of different types of information may be obtained to form the unique identifier.

For example, a media access control address and a processor identifier may be combined to form a unique identifier for the data processing system. Also, responsive to the request, the data is backed up to a storage device located on another data processing system. The unique identifier is associated with the backup.

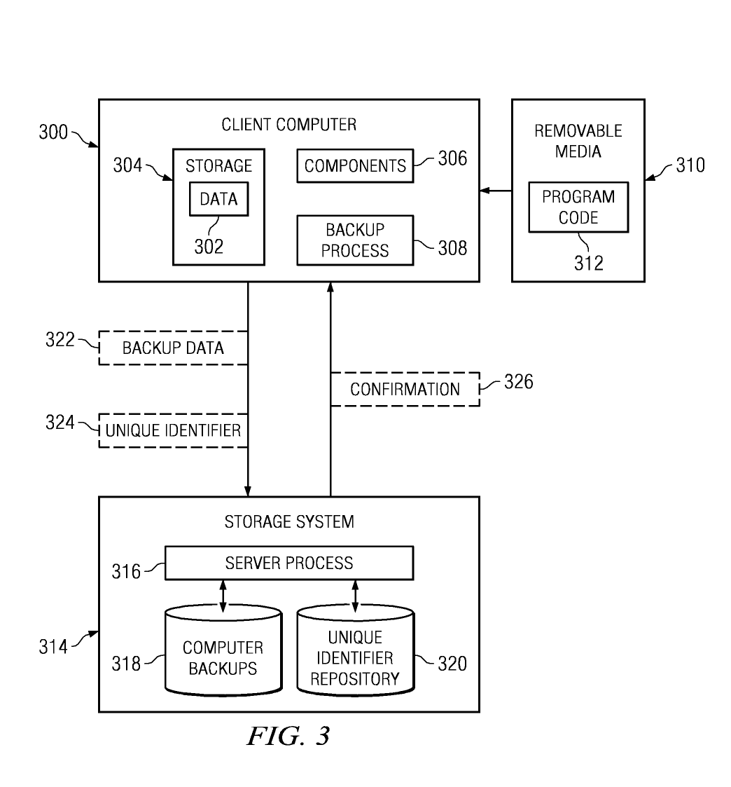

Turning now to FIG. 3, a block diagram illustrating components used in backing up data is depicted in accordance with an illustrative embodiment. In this example, client computer 300 contains data 302, storage 304, and backup process 308. Data 302 is stored on storage 304. Storage 304 is a set of storage devices that may be part of a persistent storage, such as persistent storage 208 in FIG. 2. A set, as used herein, refers to one or more items. For example, a set of storage devices is one or more storage devices.

Components 306 are a set of components within client computer 300. Components 306 are components from which information may be obtained to generate the unique identifier for client computer 300. Components 306 may include, for example, without limitation, a processor within processor unit 204, a network adapter within communications unit 210, or a file located in persistent storage 208 in FIG. 2, such a read only memory containing a serial number for client computer 300. Backup process 308 comprises program code to perform backup processes in accordance with an illustrative embodiment

In these examples, backup process 308 may be introduced into client computer 300 through removable media 310. Removable media 310, in these examples, contains program code 312. Program code 312 contains code for backup process 308 and code to boot or start client computer 300. In this manner, backup process 308 may be initiated simply by connecting removable media 310 to client computer 300 and starting client computer 300. Removable media 310 may be, for example, a compact disc, a digital versatile disc, a flash memory, or a portable disk drive.

Storage system 314 is an example of a data processing system or other suitable device or system that may store backup data. In these examples, storage system 314 includes server process 316, computer backups 318, and unique identifier repository 320. Server process 316 handles requests, such as receiving backup data for storage in computer backups 318 and retrieving backup data from computer backups 318.

Further, server process 316 also may store received unique identifiers within unique identifier repository 320. In these examples, unique identifier repository 320 associates unique identifiers with backup data in computer backups 318. These unique identifiers are used to identify backup data from computer backups 318 in response to requests received by server process 316 to send backup data to a requester. Computer backups 318 are a collection of backup data from different computers. Computer backups 318 may be stored on a set of storage devices, such as, for example, hard disk drives, tape drives, optical disk drives, and/or other suitable devices.

Unique identifier repository 320 contains unique identifiers associated with backup data within computer backups 318. Unique identifier repository 320 may be a data structure, such as, for example, a table or database containing unique identifiers. In some illustrative embodiments, unique identifier repository 320 may be unneeded. The unique identifiers may be associated with the backup data using other mechanisms. For example, the backup data in computer backups 318 may be stored in a directory named using the unique identifier. In other embodiments, the file in which the backup data is stored in computer backups 318 may be named using the unique identifier.

In this example, the backup of data 302 occurs when backup process 308 is introduced into client computer 300. Introduction of removable media 310 to client computer 300 also may be used to boot up client computer 300 in addition to executing backup process 308.

In other embodiments, backup process 308 may be introduced into client computer 300 when client computer 300 is connected to a network. A server on the network may cause client computer 300 to receive and execute backup process 308.

In this example, backup process 308 copies data 302 and sends this copied data as backup data 322 to storage system 314. Additionally, backup process 308 generates unique identifier 324 from querying components 306 in client computer 300. Unique identifier 324 may be, for example, a media access control (MAC) address of a network adapter in client computer 300. Unique identifier 324 also may be, for example, an alpha or numeric string. In other examples, the string may be entirely numeric, alphabetic characters, symbols, or some combination thereof.

In these examples, backup process 308 may identify the location of storage system 314 as a target for backup data 322 through a number of different mechanisms. For example, backup process 308 may contain an address within the program code for storage system 314. In other embodiments, backup process 308 may send a broadcast message onto the network. Server process 316 may respond to this broadcast message by returning an Internet Protocol address for storage system 314. In yet other embodiments, a user may input an address or name for storage system 314. The use of broadcast messages may be used when the greatest amount of flexibility and automation is desired in backing up data from client computer 300.

In response to receiving backup data 322 and unique identifier 324, server process 316 stores backup data 322 in computer backups 318. Unique identifier 324 may be associated with backup data 322 by server process 316 by storing unique identifier 324 in unique identifier repository 320 in association with backup data 322 stored within computer backups 318. The association also may be made by storing backup data 322 in a directory named using unique identifier 324. In other embodiments, if backup data 322 is an image in a single file, the file may be named using unique identifier 324. An image is a file or set of files that contains all of the information needed to replicate the structure, content layout, and content of a storage device. In response to receiving backup data 322 and unique identifier 324, server process 316 returns confirmation 326 to backup process 308.

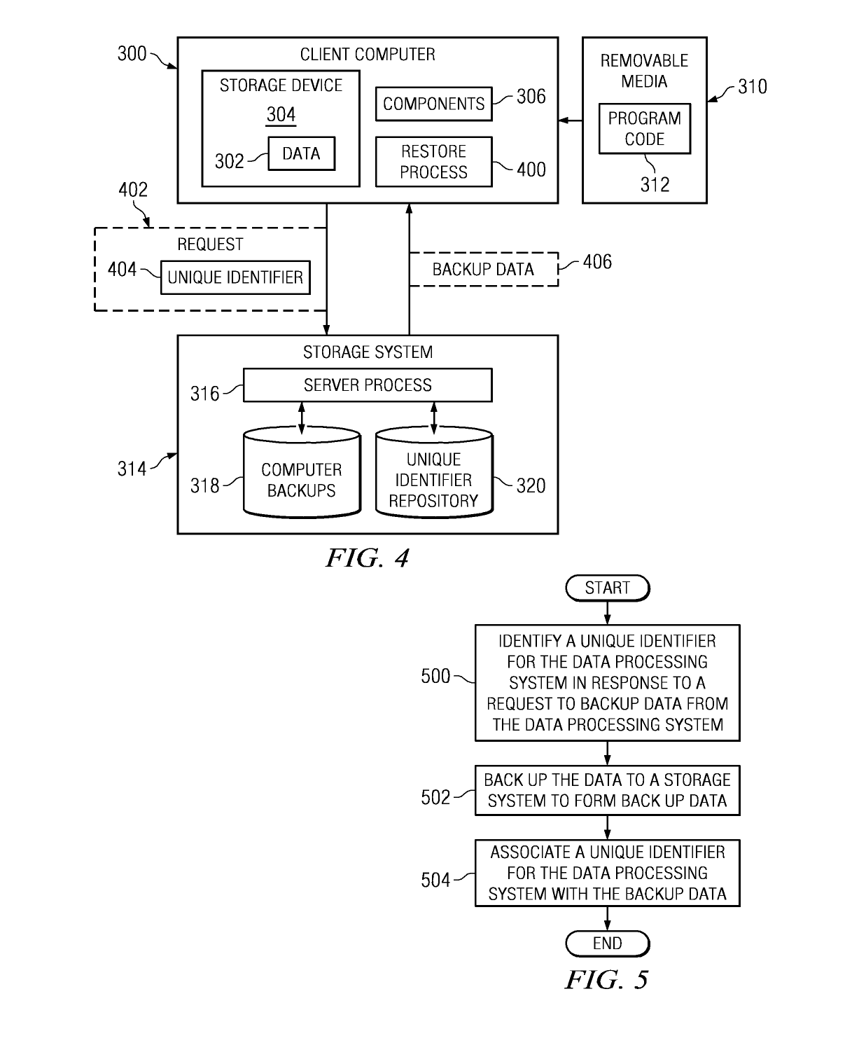

Turning now to FIG. 4, a diagram illustrating components used in restoring data is depicted in accordance with an illustrative embodiment. In this example, restore process 400 is introduced into client computer 300 through removable media 310. Restore process 400 identifies the unique identifier for client computer 300 by querying components 306. Restore process 400 sends request 402 with unique identifier 404 to server process 316. In these examples, request 402 may be broadcasted for all data processing systems to examine. In other embodiments, request 402 may be directed towards storage system 314.

In response to receiving request 402, server process 316 identifies the backup data associated with client computer 300 in computer backups 318. This identification is made using unique identifier 404. The located data is returned as backup data 406 to client computer 300. Restore process 400 then restores data 302 using backup data 406. As a result, any loss or corruption of data 302 may be repaired.

Thus, the different illustrative embodiments described in these examples provide an automated process for backing up and restoring data. By booting client computer 300 with removable media 310, the backup process performed may be entirely automated without requiring user input. This type of automated process may be beneficial because the process allows for full backups of a data processing system, such as client computer 300, to be made without a user having to enter parameters to the software or being present to start the backup.

As a result, a user is freed to perform other tasks or start additional automated backups. Further, the different illustrative embodiments also allow an uneducated or unskilled person to perform these backups while a technician performing maintenance and repair operations may spend their time on other tasks.

The illustration of different components in FIGS. 4 and 5 are presented for purposes of illustrating one manner in which an illustrative embodiment may be implemented. The illustrated blocks are not meant to imply architectural limitations as to the implementation of the different features. For example, backup process 308 and restore process 400 may be implemented as a single program rather than as separate components, as illustrated in these examples.

Turning now to FIG. 5, a high level flowchart of a process for backing up data is depicted in accordance with an illustrative embodiment. The process illustrated in FIG. 5 may be implemented in a backup process, such as backup process 308 FIG. 3.

The process begins by identifying a unique identifier for the data processing system in response to a request to backup data from the data processing system (step 500). In these examples, the unique identifier may be obtained from information for different components within the data processing system.

For example, the unique identifier may be at least one of a media access control address for a network adapter in the data processing system, a processor identifier for a processor in the data processing system, and a serial number for the data processing system. The use of “at least one”, in these examples, may be a media access control address, the processor identifier, the serial number, the media access control address and the process identifier, the serial number and the process identifier, or some other combination of these items. Of course, other information may be obtained from various components in the data processing system to form the unique identifier in these examples.

The process then backs up the data to a storage system to form the backup data (step 502). The backup data formed in step 502 may be compressed and/or encrypted, depending on the particular implementation. These options may be preset in the backup process in these examples. Of course, in other embodiments, the user may be provided with options to set these parameters.

The process then associates a unique identifier for the data processing system with the backup data (step 504), with the process terminating thereafter. In these examples, the backup process may make this association by sending the unique identifier with the backup data. The storage server identifies this association from the information received from the backup process.

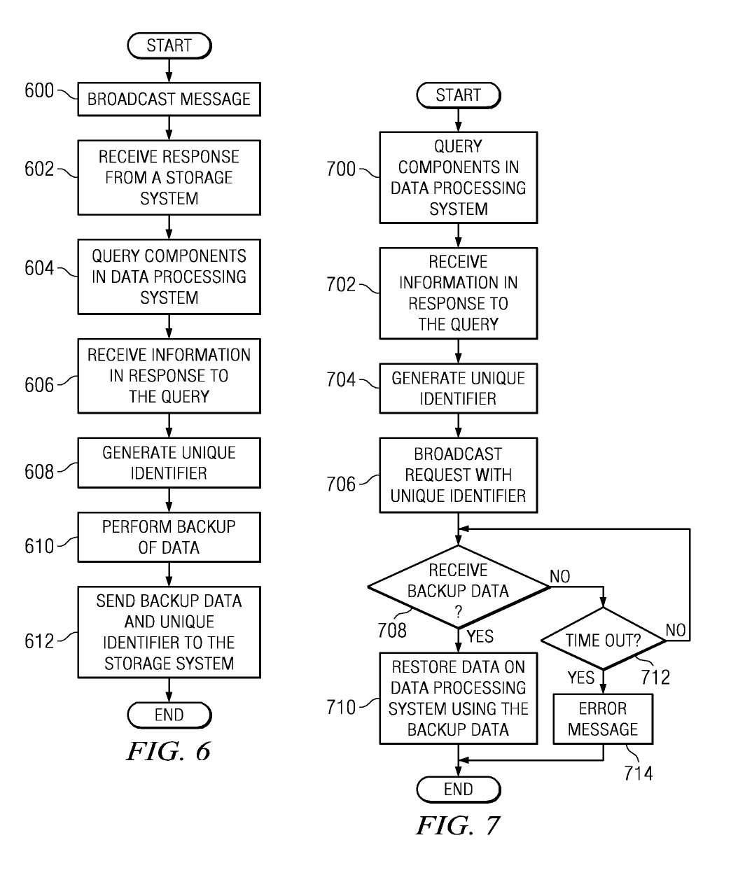

Turning now to FIG. 6, a flowchart of a process for backing up data is depicted in accordance with an illustrative embodiment. The process illustrated in FIG. 6 may be implemented in a software component, such as backup process 308 in FIG. 3.

The process begins by broadcasting a message onto the network to which the client computer is connected (step 600). This broadcast involves sending the message onto the network such that any data processing system may receive the message. In these examples, the message requests an address for a storage system. Any storage system located on the network may respond to this request.

The process receives a response from a storage system (step 602). In these examples, the response takes the form of an Internet Protocol address. Of course, other location or identification information of the storage system may be used, depending on the particular implementation.

The process then queries components in the data processing system (step 604). In this example, the query may be made to various components, such as a network adapter, to obtain a media access control address. The query also may be made to a processor to obtain a processor identifier. Also, the query may be made to a component or a file to identify a serial number for the data processing system. Information is received in response to the query (step 606).

A unique identifier is then generated from the information (step 608). The unique identifier may be any one of these pieces of information or some combination of this and some other suitable information for uniquely identifying the data processing system.

Thereafter, the process performs a backup of the data on the data processing system (step 610). This backup may be from a set of storage devices located on the data processing system. The backup performed in step 610 may involve merely the transfer of selected files or entire images of each storage device. The particular form in which the backup data takes may vary depending on the particular implementation. The process then sends the backup data and the unique identifier to the storage system (step 612) with the process terminating thereafter.

Turning now to FIG. 7, a flowchart of a process for restoring backup data is depicted in accordance with an illustrative embodiment. The process illustrated in FIG. 7 may be implemented in a software component, such as restore process 400 in FIG. 4.

The process begins by querying components in the data processing system (step 700). The process receives information in response to the query (step 702). The query in step 700 is similar to the query in step 604 in FIG. 6. This query is made to obtain information for use in generating a unique identifier.

The process generates a unique identifier from the information received in response to the query (step 704). This unique identifier is used to identify the backup data that is to be requested to perform the restore process. The process then broadcasts a request with the unique identifier (step 706). In this example, the broadcast may be received by any data processing system connected to the network. The broadcast is a request for backup data to perform a restoration of data on the data processing system.

The process then determines whether backup data is received in response to the request (step 708). If backup data is received, the process restores the data on the data processing system using the backup data (step 710), with the process terminating thereafter.

With reference again to step 708, if backup data is not received from the request, a determination is made as to whether a time out has occurred (step 712). If a time out has not occurred, the process returns to step 708. If a time out has occurred, an error message is generated (step 714), and the process terminates thereafter.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of computer usable or readable program code, which comprises one or more executable instructions for implementing the specified function or functions.

In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the different illustrative embodiments provide a computer implemented method, apparatus, and computer usable program code for backing up data. In response to a request to backup data from a data processing system, a unique identifier is identified for the data processing system. Also responsive to the request to backup data, the data is transferred to a storage system to create backup data. A unique identifier for the data processing system is associated with the backup data.

The unique identifier may be used to restore the data when a restore process is performed for the data processing system. The unique identifier, in these examples, may be generated or identified from a set of components within the data processing system. In one illustrative example, the unique identifier is a media access control address. Of course, other types of unique identifiers may be generated using the data processing system. In this manner, a restore process only uses the same components to generate the unique identifier. As a result, the unique identifier does not have to be known to the restore process.

Further, the different illustrative embodiments also provide for a fully automated backup and restore process. With the backup process, the media containing the backup process only needs to be introduced into the data processing system. In some embodiments, the removable media also may include boot code to boot the data processing system and start the backup process. A similar apparatus may be used for the restore process.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. For example, in some embodiments, multiple unique identifiers may be generated from different components in the components. Each of these unique identifiers is valid for use in identifying or locating backup data. This type of unique identifier generation is useful for the case in which one of the components may fail or be replaced. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for backing up data, the computer implemented method comprising:
responsive to a request to backup the data from a data processing system, identifying a unique identifier for the data processing system;
responsive to the request, backing up the data to a storage system to form backup data; and
associating the unique identifier for the data processing system with the backup data.

2. The computer implemented method of claim 1, wherein the request comprises an insertion of a storage media containing boot code and a backup process and wherein the identifying step comprises:
booting the data processing system using the boot code on the storage media;
executing the backup process, wherein the backup process queries a set of components in the data processing system; and
identifying the unique identifier from information received in response to the queries.

3. The computer implemented method of claim 1 further comprising:
responsive to the data processing system establishing a connection to a network, receiving a backup process from a server on the network, wherein receipt of the backup process on the data processing system is the request and wherein the identifying step comprises:
executing the backup process on the data processing system;
executing the backup process, wherein the backup process queries a set of components in the data processing system; and
identifying the unique identifier from information received in response to the queries.

4. The computer implemented method of claim 1, wherein the backing up step comprises:
transferring a set of files located on the data processing system to the storage system.

5. The computer implemented method of claim 1, wherein the data is stored on a storage device in the data processing system and wherein the backing up step comprises:
sending an image of the data on the storage device to the storage system.

6. The computer implemented method of claim 1, wherein the backup up step comprises:
broadcasting a message onto a network on which the storage system is located, wherein the message requests an address for use in sending the data;
receiving a response from the storage system in response to the messaging being broadcasted onto the network, wherein the response includes a location of the storage system; and
backup up the data to the storage system using the location received from the storage system to form the backup data.

7. The computer implemented method of claim 1, wherein the unique identifier is at least one of a media access control identifier for a network adapter in the data processing system, a processor identifier for a processor in the data processing system, and a serial number for the data processing system.

8. The computer implemented method of claim 1, further comprising:
responsive to a request to restore the data to the data processing system, identifying the data processing system using the unique identifier to form a target data processing system; and
sending the backup data associated with the unique identifier to the target data processing system.

9. The computer implemented method of claim 1, further comprising:
receiving a restore request;
locating an address for the storage system in response to receiving the restore request;
querying a set of components in the data processing system to obtain information in response to receiving the restore request;
identifying the unique identifier from the information;
retrieving the backup data for the data processing system from the storage system using the unique identifier to form retrieved backup data; and
restoring the data on the data processing system using the retrieved backup data.

10. A data processing system comprising:
a bus;
a communications unit connected to the bus;
a storage device including computer usable program code; and
a processor unit connected to the bus, wherein the processor unit executes the computer usable program to identify a unique identifier for the data processing system, in response to a request to backup data from a data processing system; backing up the data to a storage system to form backup data, in response to the request; and associate the unique identifier for the data processing system with the backup data.

11. The data processing system of claim 10, wherein the processor unit further executes the computer usable program code, wherein the request comprises an insertion of a storage media containing boot code and a backup process, and wherein in executing the computer usable program code to identify the unique identifier for the data processing system, in response to the request to backup data from a data processing system, the processor executes the computer usable program code to boot the data processing system using the boot code on the storage media; execute the backup process, wherein the backup process queries a set of components in the data processing system; and identify the unique identifier from information received in response to the queries.

12. The data processing system of claim 10 wherein the processor unit further executes the computer usable program code, wherein receipt of the backup process on the data processing system is the request and wherein in executing the computer usable program code to identify a unique identifier for the data processing system, in response to the data processing system establishing a connection to a network, receiving a backup process from a server on the network, the processor executes the computer usable program code to execute the backup process on the data processing system; execute the backup process, wherein the backup process queries a set of components in the data processing system; and identify the unique identifier from information received in response to the queries.

13. The data processing system of claim 10, the processor unit further executes the computer usable program code, wherein in executing the computer usable program code to back up the data to the storage system to form backup data, in response to the request, the processor executes the computer usable program code to transfer a set of files located on the data processing system to the storage system.

14. The data processing system of claim 10, wherein the data is stored on a storage device in the data processing system and wherein in executing the computer usable program code to backing up the data to a storage system to form backup data, in response to the request, the processor executes the computer usable program code to send an image of the data on the storage device to the storage system.

15. The data processing system of claim 10, wherein in executing the computer usable program code to back up the data to the storage system to form backup data in response to the request, the processor executes the computer usable program code to broadcast a message onto a network on which the storage system is located, wherein the message requests an address for use in sending the data; receive a response from the storage system in response to the messaging being broadcasted onto the network, wherein the response includes a location of the storage system; and backup the data to the storage system using the location received from the storage system to form the backup data.

16. A computer program product for backing up data, the computer program product comprising:
a computer readable media;
program code, stored on the computer readable media, responsive to a request to backup the data from a data processing system, for identifying a unique identifier for the data processing system;
program code, stored on the computer readable media, responsive to the request, for backing up the data to a storage system to form backup data; and
program code, stored on the computer readable media for associating the unique identifier for the data processing system with the backup data.

17. The computer program product of claim 16, wherein the request comprises an insertion of a storage media containing boot code and a backup process and wherein the program code, stored on the computer readable media, responsive to a request to backup data from a data processing system, for identifying a unique identifier for the data processing system;
program code, stored on the computer readable media for booting the data processing system using the boot code on the storage media;
program code, stored on the computer readable media for executing the backup process, wherein the backup process queries a set of components in the data processing system; and
program code, stored on the computer readable media for identifying the unique identifier from information received in response to the queries.

18. The computer program product of claim 16 further comprising:
program code, stored on the computer readable media responsive to the data processing system establishing a connection to a network, for receiving a backup process from a server on the network, wherein receipt of the backup program on the data processing system is the request and wherein the program code, stored on the computer readable media, responsive to the request to backup the data from the data processing system, for identifying the unique identifier for the data processing system comprises:
program code, stored on the computer readable media for executing the backup process on the data processing system;
program code, stored on the computer readable media for executing the backup process, wherein the backup process queries a set of components in the data processing system; and
program code, stored on the computer readable media for identifying the unique identifier from information received in response to the queries.

19. The computer program product of claim 16, wherein the program code, stored on the computer readable media, responsive to the request, for backing up the data to the storage system to form the backup data comprises:
program code, stored on the computer readable media for transferring a set of files located on the data processing system to the storage system.

20. The computer program product of claim 16, wherein the data is stored on a storage device in the data processing system and wherein the program code, stored on the computer readable media responsive to the request, for backing up the data to a storage system to form backup data comprises:
program code, stored on the computer readable media for sending an image of the data on the storage device to the storage system.
